(19) United States
(12) Patent Application Publication
(10) Pub. No.: US 2009/0301860 A1
(43) Pub. Date: Dec. 10, 2009

(54) GAS EXCITATION APPARATUS HAVING SUSPENDED ELECTRODE AND GAS EXCITATION METHOD

(75) Inventors: Akemitsu Iida, Tokyo (JP); Takayuki Kawakita, Tokyo (JP)

Correspondence Address: HESLIN ROTHENBERG FARLEY & MESITI PC, 5 COLUMBIA CIRCLE, ALBANY, NY, 12203, US

(73) Assignee: NITTETSU MINING CO., LTD., Tokyo (JP)

(21) Appl. No.: 11/915,928

(22) PCT Filed: May 31, 2006
(86) PCT No.: PCT/JP2006/310856

§ 371 Date: Nov. 29, 2007

(30) Foreign Application Priority Data
May 31, 2005 (JP) 2005-160084

(51) Int. Cl. B01J 19/08

(52) U.S. Cl. 204/157.15; 422/186.21

(57) ABSTRACT

An apparatus for exciting a gas, comprising at least a pair of electrodes connecting to an alternating current source in a housing having an inlet opening for a gas to be treated and an outlet opening for a gas which has been treated, characterized in that one electrode of the pair of the electrodes is a suspended electrode arranged by placing it under a tension at a predetermined position in the housing, the other electrode of the pair of the electrodes is a buried electrode arranged at a predetermined position by being buried in the holding wall of the housing at the end thereof, an electrode portion of the buried electrode contains a linear or planar discharging portion as a whole, and the electrode portion of the suspended electrode, opposed to the electrode portion of the buried electrode, has discharging portions where a distance from the electrode portion of the buried electrode becomes cyclically short.

### TECHNICAL FIELD

The present invention relates to a gas excitation apparatus having a suspended electrode, and a gas excitation method.

### BACKGROUND ART

Various apparatuses are known as a gas exciting apparatus for guiding a gas to attain an AC high-voltage dischargeable condition to excite gas molecules, and generate a low-temperature plasma (for example, Patent References No. 1 and No. 2). A typical embodiment of the conventionally known gas exciting apparatus is shown in FIG. 4. FIG. 4 is a schematic perspective view illustrating a gas exciting apparatus P, with a part of the sidewall of the housing 1 shown as broken away. The gas exciting apparatus P comprises a generally rectangular parallelepiped housing 1 having an inlet opening 2 for a gas G to be treated and an outlet opening 3 for the gas C which has been treated. In the housing 1, there are many hollow-cylindrical protected electrodes 6. As shown in FIG. 5, a schematic sectional view, the hollow-cylindrical protected electrode 6 contains a bar electrode 6X, and a hollow-cylindrical sheath 6Y surrounding the bar electrode 6X. The hollow-cylindrical sheath 6Y is made of an insulating material. The hollow-cylindrical protected electrodes 6 are divided into two electrodes-groups 6A, 6B, each of which is connected to the electric cables 9A, 9B, which are connected to the AC source 9. Generally, the electric cable 9B connected to the electrodes-group 6B is grounded. As shown in FIG. 5, each of the protected electrodes 6B which are located in the outermost positions in the housing 1, and thus face the inner wall of the housing 1, is connected to the electric cable 9B which is grounded, to prevent a discharge between the protected electrodes 6B and the inner walls of the housing 1. In principle, it is not necessary that the housing 1 per se and the electrodes-group 6B are grounded, but is preferable for safety reasons.

The purpose of FIGS. 4 and 5 is to illustrate the electrodes-alignment or the like of a typical embodiment of the conventional gas excitation apparatus, and thus the constitution of the apparatus is simplified, for example, the number of the electrodes illustrated is greatly decreased. It is a matter of fact that it is necessary to install a large number of the electrodes in the gas excitation apparatus. Therefore, as shown in FIG. 6, an electrodes-block Q is formed from a certain number of the electrodes, and plural electrodes-blocks Q are installed in the gas excitation apparatus. The electrodes-block Q as shown in FIG. 6 comprises a hollow-cylindrical protected electrode 6, a left side plate 8A, a right side plate 8B, a central supporting plate 8C, and lead wires 9A, 9B. The hollow-cylindrical protected electrodes 6 are supported by being passed into through-holes provided in the central supporting plate 8C arranged in the middle between the left side plate 8A and the right side plate 8B and having each end introduced into each non-through recess provided in each inner wall of the left side plate 8A and the right side plate 8B.

Besides the method for generating a discharge between protected electrodes, a method for generating a discharge between protected electrodes and exposed electrodes is also known, in the conventional gas excitation apparatus. The exposed electrode is an electrode wherein a hollow-cylindrical sheath used in the protected electrode is not contained, and a bar of a hollow-cylindrical electrode is exposed. FIG. 7 schematically illustrates a structure of an electrodes-block Q′ wherein a combination of protected electrodes and exposed electrodes is used. In the electrodes-block Q′, a discharge is generated between a group of exposed electrodes 5 and a group of protected electrodes 6. The bar electrode is exposed in the exposed electrode 5, and the protected electrode 6 contains the bar core electrode 6X and the hollow-cylindrical sheath 6Y. The groups of the exposed electrodes 5 and the protected electrodes 6 are supported at the central portions thereof by the through-holes in the central supporting plate 7C, and fixed at the terminal ends thereof by a method comprising holding the ends with primary holding means 7, then dipping the whole of the end portions in a liquid resin, and curing the resin to fix the electrodes on the holding walls 7A, 7B.

In the electrodes-block Q′ as shown in FIG. 7, a uniform discharge is assured between the exposed electrodes 5 and the bar core electrodes 6X at the whole surfaces thereof facing each other, so long as a dischargeability is uniformly maintained between the exposed electrodes 5 and the bar core electrodes 6X. However, dust contained the gas to be treated may adhere to the surface of the electrodes. Particularly, as shown in FIG. 8, if the dust adheres on the surface of the exposed electrode 5D, the site to which the dust is adhered becomes more easily dischargeable than another surface of the exposed electrode. The discharge is concentrated at the above site, whereby the site is liable to be damaged at an early stage. Further, a uniform discharge is inhibited, and the excitation function is lowered.

Further, in the electrodes-block Q′ as shown in FIG. 7, it is difficult to maintain the linearity of, in particular the exposed electrode 5, with the passage of time. For example, a flexure is produced in the exposed electrode 5E as shown in FIG. 8.

When such a flexure is produced, the discharge is concentrated at the above portion, whereby the portion is liable to be damaged at an early stage. Further, a uniform discharge is inhibited, and the excitation function is lowered.

Furthermore, in the electrodes-block Q′ as shown in FIG. 7, even if the dust adhesion or the flexure as above does not occur, there is still another problem of a generation of a surface discharge. For example, in the exposed electrodes 5F as shown in FIG. 8, a surface discharge occurs in the holding walls 7A, 7B, at the wall surface 7D, 7E between the buried ends of the exposed electrode 5F and the buried ends of the protected electrode 6. The surface discharge also occurs on the central supporting plate 7C, at the wall surface 7F between the through-hole for the exposed electrode 5F and the through-hole for the exposed electrode 5F. Such a surface discharge may cause damage to the holding walls 7A, 7B or the central supporting plate 7C at an early stage, and also occurs in the exposed electrode 5D to which dust adheres or the exposed electrode 5E with a flexure in the same manner.

Therefore, the above problems in a conventional gas excitation apparatus, particularly a gas excitation apparatus wherein an exposed electrode is used have awaited a solution.

As will be mentioned below, the present invention provides a suspended electrode under a tension as a means for solving the above problems, and a coiled spring electrode as one embodiment thereof.

Discharging techniques per se using a coiled electrode are known in a prior art. For example, an ozone generating apparatus comprising an outer circumference hollow-cylindrical electrode, a round bar insulator placed at the inner center of the outer circumference hollow-cylindrical electrode, a spiral electrode formed by winding a thin metal wire on the round bar insulator, and a central bar electrode inserted into the center of the round bar insulator is known (Patent Reference No. 3). However, the spiral electrode used in the ozone generating apparatus is formed by being wound on the outer surface of the round bar insulator, the distance between the spiral electrode and the outer circumference hollow-cylindrical electrode or the central bar electrode, each of which faces the spiral electrode, is constant or does not vary, and the spiral electrode is not fixed under tension.

Further, a sterilizing apparatus comprising a coiled spring ignition electrode and a plate electrode opposing thereto whereby microorganisms in air can be broken or inactivated is known (Patent Reference No. 4). However, the coiled spring ignition electrode used in the sterilizing apparatus is intended to prolong time of passing of the microorganisms in air through the discharging area, and the Patent Reference No. 4 makes no mention of a uniformalization of the discharging condition, decrease of the surface discharge, or utilization of a tension.

### [Patent Reference No. 1]

### Japanese Unexamined Patent Publication (Kokai) No. 9-199261;

### [Patent Reference No. 2]

U.S. Pat. No. 5,483,117;

### [Patent Reference No. 3]

### Japanese Unexamined Patent Publication (Kokai) No. 2004-161509;

### [Patent Reference No. 4]

### Japanese Unexamined Patent Publication (Kokai) No. 2004-194875.

### DISCLOSURE OF INVENTION

### Problems to be Solved by the Invention

Therefore, the object of the present invention is to provide a means for solving the problems in the conventional gas excitation apparatus, particularly the gas excitation apparatus wherein an exposed electrode is used, for example, the adhesion of dust, the production of a flexure, and the generation of a surface discharge.

### Means for Solving the Problems

The above problems can be solved by the present invention, that is, an apparatus for exciting a gas, comprising at least a pair of electrodes connecting to an alternating current source in a housing having an inlet opening for a gas to be treated and an outlet opening for a gas which has been treated, characterized in that.

one electrode of the pair of the electrodes is a suspended electrode arranged by placing it under a tension at a predetermined position in the housing,
the other electrode of the pair of the electrodes is a buried electrode arranged at a predetermined position by being buried in the holding wall of the housing at the end thereof,
an electrode portion of the buried electrode contains a linear or planar discharging portion as a whole, and
the electrode portion of the suspended electrode, which is opposed to the electrode portion of the buried electrode, has discharging portions where a distance from the electrode portion of the buried electrode becomes cyclically short.

According to a preferred embodiment of the gas excitation apparatus of the present invention, the electrodes-pair is a combination of a protected electrode and a protected electrode, or a combination of a protected electrode and an exposed electrode.

According to a preferred embodiment of the gas excitation apparatus of the present invention, the protected electrode comprises a core electrode and an insulating sheath layer surrounding the core electrode.

According to a preferred embodiment of the gas excitation apparatus of the present invention, the suspended electrode is a suspended electrode composed of an energizing means as a whole, or a suspended electrode composed of a portion of a means for imparting a tension at both ends or at an end and a portion of a non-energizing means.

According to a preferred embodiment of the gas excitation apparatus of the present invention, the suspended electrode is detachably fixed via suspending means at the both ends thereof to the holding walls of the housing.

According to a preferred embodiment of the gas excitation apparatus of the present invention, the AC-source-connecting end of the suspended electrode is located at the side opposite to the AC-source-connecting end of the buried electrode in the electrodes-pair, and the non-connecting ends of the suspended electrode and/or the buried electrode contain an non-dischargeable region without a dischargeable electrode portion.

Further, the present invention relates to a method for exciting a gas, comprising passing a gas to be treated through a housing having an inlet opening for a gas to be treated, an outlet opening for a gas which has been treated, and at least a pair of electrodes connecting to an alternating current, and applying an alternating-current potential between the electrodes-pair, characterized in that one electrode of the pair of the electrodes is a suspended electrode arranged by placing it under a tension at a predetermined position in the housing, the other electrode of the pair of the electrodes is a buried electrode arranged at a predetermined position by being buried in the holding wall of the housing at the end thereof, an electrode portion of the buried electrode contains a linear or planar discharging portion as a whole, and the electrode portion of the suspended electrode, opposing the electrode portion of the buried electrode, has discharging portions where a distance from the electrode portion of the buried electrode becomes cyclically short.

### EFFECTS OF THE INVENTION

According to the present invention, the suspended electrode under tension is used, and this can prevent a flexure from being produced. Further, a change in tension with the passage of time can be corrected by the means for adjusting a tension provided at the end of the suspended electrode.

The suspended electrode under tension does not require the central supporting plate, and thus a surface discharge does not occur on the central supporting plate, even if the buried electrodes as the opposing electrode are supported by the central supporting plate. Further, when the electrode is suspended between the edges of the holding walls, the suspending means of an insulating material can be used at least at one of the holding walls, whereby a surface discharge can be more effectively reduced.

Further, the electrode portion of the suspended electrode has discharging portions where a distance from the electrode portion of the buried electrode becomes cyclically short, and thus the probability of affect by dust adhesion can be significantly reduced, that is, the affect by dust adhesion can be substantially avoided.

### BRIEF DESCRIPTION OF THE DRAWINGS

FIG. 1

A schematic illustration of the present apparatus wherein coiled spring electrodes are used.

FIG. 2

A schematic illustration of the present apparatus wherein a screw electrode is used.

FIG. 3

A schematic illustration of the present apparatus wherein a corrugated plate electrode used.

FIG. 4

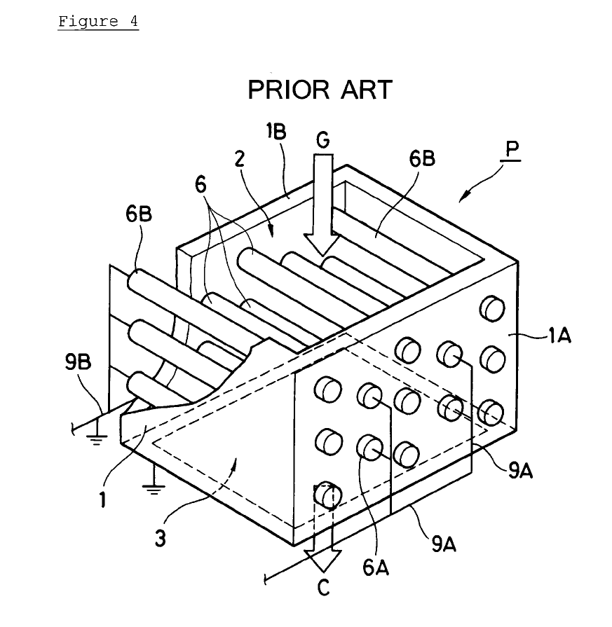

A schematic perspective view of the conventional gas excitation apparatus where a part of each side wall is shown as broken away.

FIG. 5

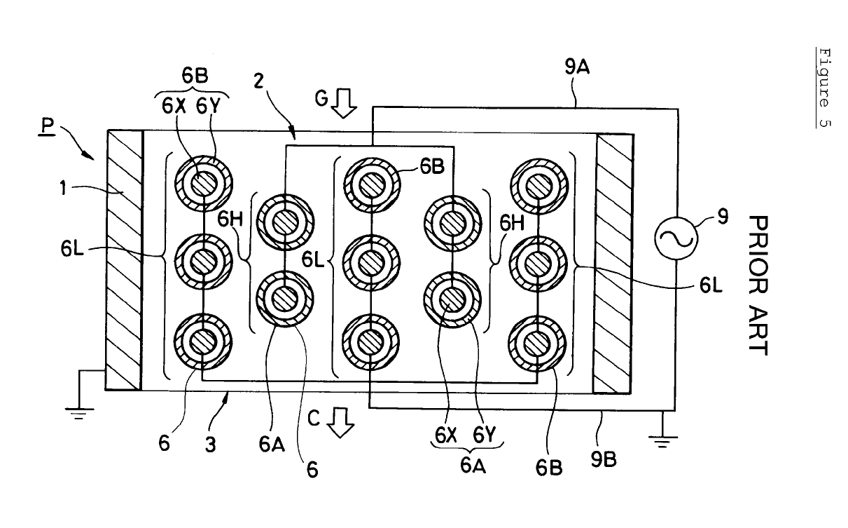

A schematic sectional view of the conventional gas excitation apparatus shown in FIG. 4.

FIG. 6

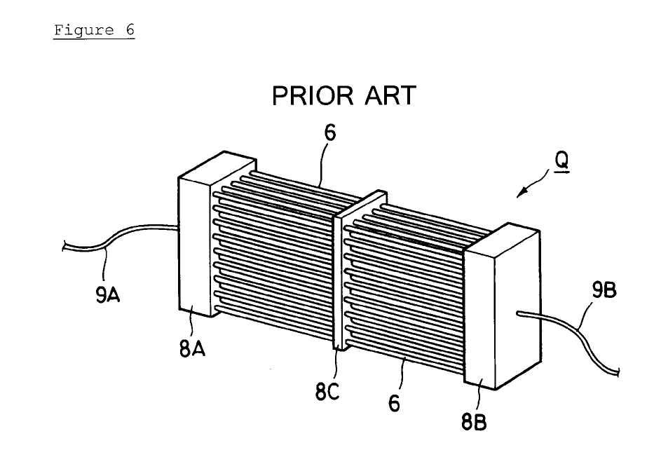

A schematic perspective view of the electrodes-block used in the conventional gas excitation apparatus.

FIG. 7

A schematic perspective view of the electrodes-block of the combination of the protected electrodes and the exposed electrodes.

FIG. 8

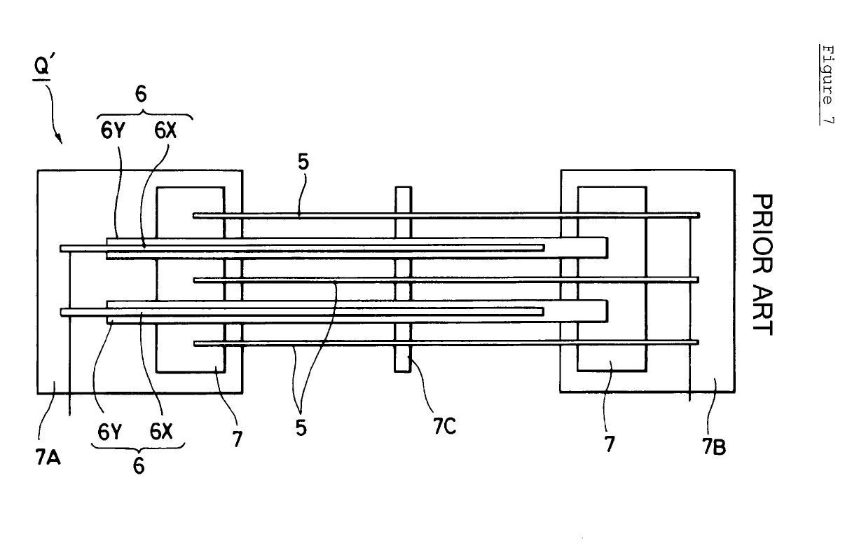

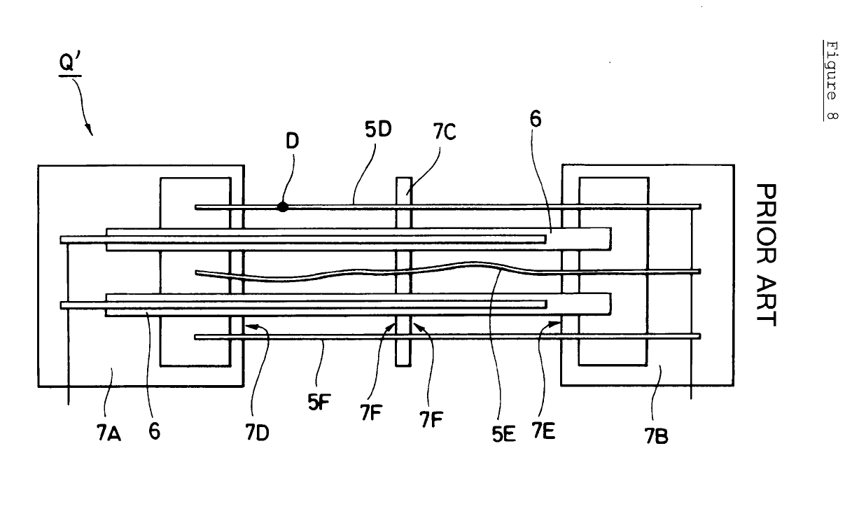

A schematic perspective view of the problems with the electrodes-block shown in FIG. 7.

### EXPLANATION OF NUMERICAL REFERENCES

1 . . . housing; 2 . . . inlet opening; 3 . . . outlet opening;
5 . . . exposed electrode;
5D . . . exposed electrode to which dust adheres;
5E . . . exposed electrode with flexure;
5F . . . exposed electrode;
6 . . . hollow-cylindrical protected electrode;
6A, 6B electrodes-group;
6L . . . first electrodes-group;
6H . . . second electrodes-group;
6X . . . bar electrode (metal electrode bar);
6Y . . . hollow-cylindrical sheath (glass sheath);
7 . . . primary holding means; 7A, 7B . . . holding wall;
7C . . . central supporting Plate;
7D, 7E, 7F . . . wall surface;
8A . . . left side plate;
8B . . . right side plate;
8c . . . central supporting plate;
9 . . . AC source; 9A, 9B . . . wire;
11 . . . coiled spring electrode;
11A, 11B . . . end of coiled spring electrode;
12A, 12B . . . suspending hook 12A;
13 . . . screw electrode;
13A, 13B . . . end of screw electrode 13A;
13T . . . thread;
14A, 14B . . . ring for coupling spring;
15 . . . spring portion;
15A . . . hook for coupling spring;
17 . . . corrugated plate electrode;
17A, 17B . . . end of corrugated plate electrode;
17T . . . linear protruded zone;
21, 22 . . . holder 21;
23A, 23B . . . ring for suspension;
31 . . . bar for suspension ring;
32 . . . means for adjusting tension; 33 . . . suspension-ring-holding bar;
34, 35 . . . lead wire;
61 . . . protected electrode;
61A, 61B . . . end of protected electrode;
61X . . . bar core electrode;
61Y . . . hollow-cylindrical sheath;
62 . . . non-dischargeable region.

### BEST MODE FOR CARRYING OUT THE INVENTION

The typical embodiments of the present apparatus will be explained with reference to the attached drawings.

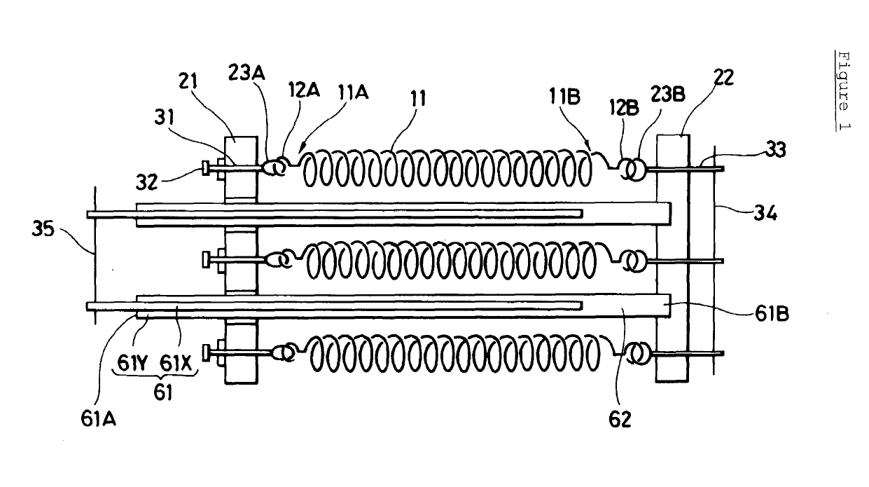

FIG. 1 schematically illustrates an embodiment using the coiled spring electrode 11 which is a typical example of the suspended electrode composed of an energizing means as a whole. The coiled spring electrode 11 has suspending hooks 12A, 12B at both ends 11A, 11B. The suspending hooks 12A, 12B can be hung on the suspension rings 23A, 23B installed in the walls of the holders 21, 22 for holding the electrodes at the ends thereof. Any means other than the combination of a hook and a ring can be used as the suspending means. For example, the suspension rings can be arranged at the both ends 11A, 11B of the coiled spring electrode 11, whereas the suspending hooks can be installed in the walls of the holders 21, 22.

The coiled spring electrode 11 is not connected to the electric source at one end 12A, but to the electric source at another end 12B. For example, at the end 11A which is not connected to the electric source, the suspension-ring-holding bar 31 can be installed in the through-hole of the holder 21 to arrange the suspension ring 23A at one end projecting toward the inner side of the holder 21, and the tension-adjusting means 32 at another end. The tension-adjusting means 32 may be composed of, for example, a means for sliding the suspension-ring-holding bar 31 in the linear direction, and a locking means capable of stopping the suspension-ring-holding bar 31 at an appropriate position, whereby the suspension ring 23A coupled at the tip of the suspension-ring-holding bar 31 can be moved forwards or backwards to change the length of the coiled spring electrode 11 and adjust the tension. The suspension-ring-holding bar 31, and the suspension ring 23A and the tension-adjusting means 32 arranged at the ends thereof are preferably made of an insulating material, respectively.

At the end 11B connecting to the electric source, the suspension-ring-holding bar 33 of a conductive material is fixedly installed in the through-hole of the holder 22, and the suspension-ring-holding bar 33 of a conductive material is connected to the electric source (not shown) via the lead wire 34.

In the present apparatus shown in FIG. 1, the protected electrode 61 is used as the electrode opposed to the suspended electrode. The protected electrode 61 is composed of the bar core electrode 61X and the hollow-cylindrical sheath 61Y surrounding the bar core electrode 61X, as in the protected electrode used in the conventional gas excitation apparatus. The hollow-cylindrical sheath 61Y is made of an insulating material. The protected electrode 61 is held by burying both ends thereof in the walls of the holders 21, 22. The holder used in the present invention may be not only a solid wall of a resin, but also a net wall or a knit wall. Therefore, the term “buried”, “burying”, or “bury” as used herein is not limited to the case of the burying in a solid resin, but includes, for example, the case of the holding in the voids of a net or the like, however, it does not include the case of fixing under a tension.

The protected electrode 61 is connected to the electric source at one end 61A, but not to the electric source at another end 61B. As shown in FIG. 1, in the holder 21 on the side where the end 11A of the suspended electrode 11 is not connected to the electric source, the end 61A of the protected electrode 61 is connected to the electric source, whereas in the holder 22 on the side where the end 11B of the suspended electrode 11 is connected to the electric source, the end 61B of the protected electrode 61 is not connected to the electric source. As an auxiliary means for holding the protected electrode 61, a central supporting plate (not shown; see FIG. 7 or the like) may be used. When such a central supporting plate is used, it must not be brought into contact with the suspended electrode.

At the end 61A on the side connecting to the electric source, in the protected electrode 61, the bar core electrode 61X is projected outwards from the end 61A of the protected electrode 61, and connected to the electric source (not shown) via the lead wire 35. When the holder 21 for holding the end 61A on the side connecting to the electric source is, for example, a net or the like, it is preferable to place an insulating resin ring on the surface thereof in contact with the holder 21, to reduce a surface discharge. On the other hand, at the end 61B on the side not connecting to the electrode source, it is preferable to form a non-dischargeable region 62 where the bar core electrode 61X is not placed within the hollow-cylindrical sheath 6Y, whereby a space between the end of the bar core electrode 61X and lead wire 34 is enlarged to reduce the surface discharge.

The coiled spring electrode 11 is an extension spring, i.e., a spring for imparting a tension inwardly in the drawing direction from the walls of the holders 21, 22. Therefore, it is possible to maintain a constant electrode-electrode distance, i.e., a distance between the coiled spring electrode 11 as the suspended electrode and the bar core electrode 61X as the opposed electrode in the protected electrode 61 as the buried electrode. The adjustment of tension under the suspended condition can be carried out by a simple procedure. The coiled spring electrode 11 has periodical and spiral turns, whereby sites where the distance from the bar core electrode of the protected electrode becomes short are cyclically formed. The discharge occurs mainly at such sites and portions therearound. However, the discharging sites are uniformly distributed, and thus, a risk of a concentrated discharge can be eliminated, and a uniform discharge can be carried out as a whole.

The coiled spring electrode 11 can be detachably suspended between the walls of the holders 21, 22, and the suspending procedure is very simple. The ease of the suspending procedure enables the production of a gas excitation apparatus requiring a periodical exchange as a precondition. For example, a diameter of the coiled spring electrode can be thinned to enhance a dischargeability or reduce an electrostatic capacity. If the electrostatic capacity is reduced, a current efficiency is enhanced, and thus the electric source can be minimized.

Further, in comparison with the prior art, the control for maintaining a constant distance between the electrodes becomes easier. Therefore, a required level for a dimensional stability of the holder for the electrodes is lowered, and the resin holding used in the prior art becomes unnecessary, whereby a weight of the apparatus can be saved.

Besides the coiled spring electrode as above, that is, an extension spring electrode formed by winding a linear spring material, such as a piano wire, in a coiled or spiral manner, there may be mentioned, as the suspended electrode composed of the energizing means as a whole, for example, an extension spring electrode formed by winding a belt-like or long-sheet-like spring material, such as a spring steel, in a coiled or spiral manner; this will be hereinafter referred to as a belt-like wound electrode. In the belt-like wound electrode, the belt-like long sheet has periodical and spiral turns, whereby sites where the distance from the bar core electrode of the protected electrode becomes short are cyclically formed. The discharge occurs mainly at such sites and portions therearound. However, the discharging sites are uniformly distributed, and thus a risk of a concentrated discharge can be eliminated, and a uniform discharge can be carried out as a whole.

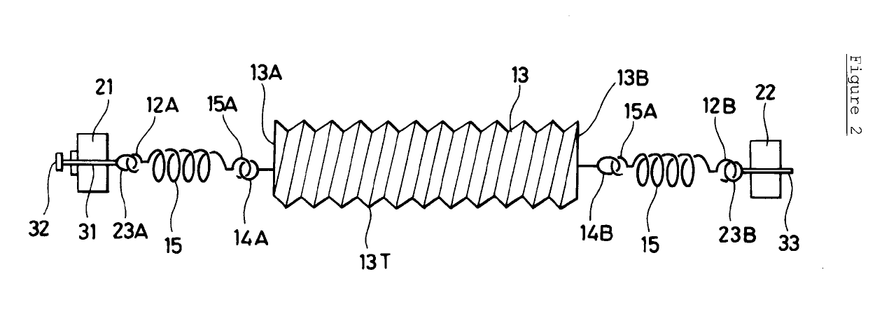

FIG. 2 schematically illustrates another embodiment of the suspended electrode which may be used in the present invention, that is, the suspended electrode composed of a portion or portions of a means for imparting a tension at both ends or at one end, and a portion of a non-energizing means.

In this embodiment, the screw electrode 13 is used as the electrode portion of the suspended electrode. The screw electrode 13 has spring-coupling rings 14A, 14B at both ends 13A, 13B, and preferably at positions on the central axis of the screw electrode 13. The spring-coupling rings 14A, 14B are detachably coupled with the spring-coupling hooks 15A, 15A contained at the ends of the spring portions 15, 15 as a respective means for imparting a tension. Further, the spring portions 15, 15 are equipped with the suspending hooks 12A, 12B at the opposite ends. The suspending hooks 12A, 12B can be detachably hung on the suspension rings 23A, 23B installed on the walls of the holders 21, 22 for holding the electrodes at both ends thereof.

The screw electrode 13 is also not connected to the electric source at one end 13A, but to the electric source at another end 13B. At the end 13A which is not connected to the electric source, the screw electrode 13 is coupled, via the spring portion 15, with the suspension ring 23A of the suspension-ring-holding bar 31 installed in the through-hole of the holder 21. A tension can be adjusted by the tension-adjusting means 32 arranged on the tip of the suspension-ring-holding bar 31. It is preferable that the suspension-ring-holding bar 31, the suspension ring 23A arranged on the tip thereof, and the tension-adjusting means 32 are made of an insulating material, respectively.

At the end 13B connecting to the electric source, the screw electrode 13 is connected to the electric source (not shown), via the spring portion 15 of a conductive material, the conductive suspension ring 23B, and the conductive suspension-ring-holding bar 33. The suspension-ring-holding bar 33 is fixedly installed in the through-hole of the holder 22.

In the embodiment wherein the suspended electrode as shown in FIG. 2 is used, the protected electrode used as the opposed electrode is connected to the electric source at one end, but not connected to the electric source at another end. It is preferable, in view of the reduction of the surface discharge, that the holder 21 holding the screw electrode 13 at the end thereof not connecting to the electric source holds the protected electrode at the end thereof connecting to the electric source, whereas the holder 22 holding the screw electrode 13 at the end thereof connecting to the electric source holds the protected electrode at the end thereof not connecting to the electric source. Further, when a central supporting plate is used as an auxiliary means for holding the protected electrode, it is preferable that such a plate is not brought into contact with the screw electrode 13, in view of a reduction of the surface discharge. It is also preferable, in view of the reduction of the surface discharge, that the protected electrode contains an undischargeable region without the bar core electrode, at the end thereof not connecting to the electric source.

Each of the spring portions 15 coupled to both ends of the screw electrode 13 is an extension spring, i.e., a spring for energizing in the drawing direction, and therefore, imparts a tension such that the screw electrode 13 is drawn in the direction to the walls of the holders 21, 22. It is possible to maintain a constant distance between the screw electrode 13 and the bar core electrode as the opposed electrode in the protected electrode, by the tension imparted by the spring portions 15. The adjustment of tension under the suspended condition can be carried out by a simple procedure. The screw electrode 13 carries thereon a thread 13T having periodical and spiral turns, whereby sites where the distance from the bar core electrode of the protected electrode becomes short are cyclically formed. The discharge occurs mainly at such sites and portions therearound. However, the discharging sites are uniformly distributed, and thus the risk of a concentrated discharge can be eliminated, and a uniform discharge can be carried out as a whole. Further, the suspending procedure is very easy, and thus the screw electrode 13 has the same advantage as that of the coiled spring electrode.

In the embodiment using the screw electrode 13 shown in FIG. 2, it is possible to omit one of the spring portions 15, arranged at both ends 13A, 13B. That is, it is possible that the spring portion 15 is arranged at one end 13A, but not at another end 13B, or is not arranged at one end 13A, but arranged at another end 13B. At the end without the spring portion, one of the spring-coupling rings 14A, 14B or one of the suspension rings 23A, 23B can be replaced with a coupling hook for a direct coupling.

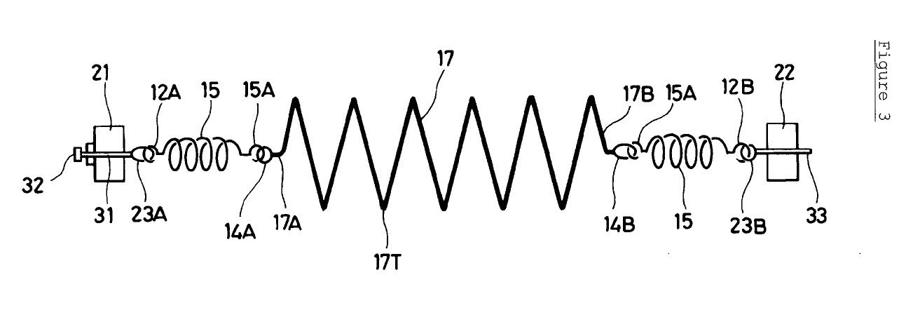

FIG. 3 schematically illustrates still another embodiment of the suspended electrode which may be used in the present invention.

In this embodiment, the corrugated plate electrode 17 is used as the electrode portion of the suspended electrode. The corrugated plate electrode 17 is effective, when the exposed electrode opposing thereto has a plate core electrode. The corrugated plate electrode 17 has spring-coupling rings 14A, 14B at both ends 17A, 17B. The spring-coupling rings 14A, 14B are detachably coupled with the spring-coupling hooks 15A, 15A contained at the ends of the spring portions 15, 15 as a respective means for imparting a tension. Further, the spring portions 15, are equipped with the suspending hooks 12A, 12B at the opposite ends. The suspending hooks 12A, 12B can be detachably hung on the suspension rings 23A, 23B installed on the walls of the holders 21, 22 for holding the electrodes at both ends thereof.

The corrugated plate electrode 17 is also not connected to the electric source at one end 17A, but is connected to the electric source at another end 17B. At the end 17A which is not connected to the electric source, the corrugated plate electrode 17 is coupled, via the spring portion 15, with the suspension ring 23A of the suspension-ring-holding bar 31 installed in the through-hole of the holder 21. A tension can be adjusted by the tension-adjusting means 32 arranged on the tip of the suspension-ring-holding bar 31. It is preferable that the suspension-ring-holding bar 31, the suspension ring 23A arranged on the tip thereof, and the tension-adjusting means 32 are made of an insulating material, respectively.

At the end 17B connecting to the electric source, the corrugated plate electrode 17 is connected to the electric source (not shown), via the spring portion 15 of a conductive material, the conductive suspension ring 23B, and the conductive suspension-ring-holding bar 33. The suspension-ring-holding bar 33 is fixedly installed in the through-hole of the holder 22.

In the embodiment wherein the suspended electrode as shown in FIG. 3 is used, the protected electrode used as the opposed electrode is connected to the electric source at one end, but not connected to the electric source at another end. It is preferable, in view of a reduction of the surface discharge, that the holder 21 holding the corrugated plate electrode 17 at the end thereof not connecting to the electric source holds the protected electrode at the end thereof connecting to the electric source, whereas the holder 22 holding the corrugated plate electrode 17 at the end thereof connecting to the electric source holds the protected electrode at the end thereof not connecting to the electric source. Further, when a central supporting plate is used as an auxiliary means for holding the protected electrode, it is preferable that such a plate is not brought into contact with the corrugated plate electrode 17, in view of a reduction of the surface discharge. It is also preferable, in view of a reduction of the surface discharge, that the protected electrode contains an non-dischargeable region without the bar core electrode, at the end thereof not connecting to the electric source.

Each of the spring portions 15 coupled to both ends of the corrugated plate electrode 17 is an extension spring, i.e., a spring for energizing in the drawing direction, and therefore, imparts a tension such that the corrugated plate electrode 17 is drawn in the direction toward the walls of the holders 21, 22. It is possible to maintain a constant distance between the corrugated plate electrode 17 and the plate core electrode as the opposed electrode in the protected electrode, by the tension imparted by the spring portions 15. The adjustment of tension under the suspended condition can be carried out by a simple procedure. The corrugated plate electrode 17 carries thereon belt-like protruded zones 17T, whereby sites where the distance from the plate core electrode of the protected electrode becomes short are cyclically formed. The discharge occurs mainly at such sites and portions therearound. However, the discharging sites are uniformly distributed, and thus a risk of a concentrated discharge can be eliminated, and a uniform discharge can be carried out as a whole. Further, the suspending procedure is very easy, and thus the corrugated plate electrode 17 has the same advantage as that of the coiled spring electrode.

In the embodiment using the corrugated plate electrode 17 shown in FIG. 3, it is possible to omit one of the spring portions 15, 15 arranged at both ends 17A, 17B. That is, it is possible that the spring portion 15 is arranged at one end 17A, but not at another end 17B, or is not arranged at one end 17A, but arranged at another end 17B. At the end without the spring portion, one of the spring-coupling rings 14A, 14B or one of the suspension rings 23A, 23B can be replaced with a coupling hook for a direct coupling. In the embodiment using the corrugated plate electrode 17 shown in FIG. 3, it is possible to effectively prevent or reduce the rotation of the corrugated plate electrode 17 by omitting the spring portion 15 at one of the ends 17A, 17B. Further, plural (for example, two) spring-coupling rings 14A, 14B may be arranged parallel to each other in the width direction at each of the ends 17A, 17B of the corrugated plate electrode 17, and plural spring portions 15, 15 may be suspended in parallel between plural suspension rings 23A, 23B installed in parallel on each of the walls of the holders 21, 22, whereby the corrugated plate electrode 17 can be easily maintained parallel to the plate core electrode of the exposed electrode used as the opposed electrode.

In the gas excitation apparatus, the electrodes-pairing of the suspended electrode and the buried electrode may be a combination of the protected electrode and the protected electrode, or a combination of the protected electrode and the exposed electrode. As shown in FIGS. 1 to 3, it is preferable to use the exposed electrode as the suspended electrode and the protected electrode as the buried electrode. Both the suspended electrode and the buried electrode may be the protected electrode. When the protected electrode is used as the suspended electrode, the coiled spring electrode, the screw electrode, or the corrugated plate electrode may be coated with, for example, an insulating material to form an insulating sheath layer. The insulating sheath layer may be formed, for example, by coating the surface of the electrode with a hyaline glaze and calcining the whole.

In the gas excitation apparatus according to the present invention, the core electrode in the protected electrode may be a bar, a solid-cylinder, a hollow-cylinder, or a plate. The insulating sheath layer surrounding the core electrode may be the coating layer as above, or a glass tube. In the latter case, the core electrode does not come into direct contact with the insulating sheath layer.

As the suspended electrode composed of the energizing means as a whole, there may be mentioned the coiled spring electrode or the belt-like wound electrode as above. The suspended electrode composed of a tension-imparting-means portion or portions installed at one or both ends and a portion of the non-energizing means is not limited to the screw electrode or the corrugated plate electrode as mentioned above, but may be mentioned, for example, a spheres-interlocked electrode containing an electrode portion composed of interlocked spheres formed by linearly coupling a plurality of spheres (including elliptic spheres); a spheres-strand electrode containing an electrode portion composed of a spheres-strand formed by fitting a string introduced into through-holes of the spheres (including elliptic spheres); a wire-rope electrode containing an electrode portion composed of a wire-rope formed by spirally twisting one or more nets on the surface of a solid-cylindrical core; a projected-flanges electrode containing an electrode portion composed of a solid cylinder carrying projected flanges uniformly spaced from each other on the surface of a solid-cylindrical core; a torsional electrode containing an electrode portion formed by twisting a belt or long sheet of an electrode material in a width direction; or a chain electrode containing an electrode portion of a chain. The above electrodes may be used in combination.

The gas excitation apparatus according to the present invention may contain parts or components used in the conventional gas excitation apparatus, such as those disclosed in Japanese Unexamined Patent Publication (Kokai) No. 9-199261 or U.S. Pat. No. 5,483,117, other than the suspended electrode, the means of suspending the suspended electrode, and the coupling means.

### INDUSTRIAL APPLICABILITY

The present invention can be utilized in, for example, a deodorizing apparatus or an air cleaning apparatus, by guiding a gas to attain an AC high-voltage dischargeable condition to excite gas molecules, and generate a low-temperature plasma.

As above, the present invention was explained with reference to particular embodiments, but modifications and improvements obvious to those skilled in the art are included in the scope of the present invention.

1. An apparatus for exciting a gas, comprising at least a pair of electrodes connecting to an alternating current source in a housing having an inlet opening for a gas to be treated and an outlet opening for a gas which has been treated, wherein
one electrode of the pair of the electrodes is a suspended electrode arranged by placing it under a tension at a predetermined position in the housing,
the other electrode of the pair of the electrodes is a buried electrode arranged at a predetermined position by being buried in the holding wall of the housing at an end thereof,
an electrode portion of the buried electrode contains a linear or planar discharging portion as a whole, and
the electrode portion of the suspended electrode, which is opposed to the electrode portion of the buried electrode, has discharging portions where a distance from the electrode portion of the buried electrode becomes cyclically short.

2. The apparatus for exciting a gas, according to claim 1, wherein the discharging portion is distributed uniformly with respect to the electrode portion of the buried electrode.

3. The apparatus for exciting a gas, according to claim 1, wherein the electrodes-pairing is a combination of a protected electrode and a protected electrode, or a combination of a protected electrode and an exposed electrode.

4. The apparatus for exciting a gas, according to claim 1, wherein the protected electrode comprises a core electrode and an insulating sheath layer surrounding the core electrode.

5. The apparatus for exciting a gas, according to claim 1, wherein the suspended electrode is a suspended electrode composed of an energizing means as a whole, or a suspended electrode composed of a portion of a means for imparting a tension at both ends or an end and a portion of a non-energizing means.

6. The apparatus for exciting a gas, according to claim 1, wherein the suspended electrode is detachably fixed via suspending means at the both ends thereof on the holding walls of the housing.

7. The apparatus for exciting a gas, according to claim 1, wherein one of the suspending means coupling the suspended electrode has a means for adjusting a tension.

8. The apparatus for exciting a gas, according to claim 1, wherein the AC-source-connecting end of the suspended electrode is located at the opposite side to the AC-source-connecting end of the buried electrode in the electrodes-pair, and the non-connecting ends of the suspended electrode and/or the buried electrode contain an non-dischargeable region without a dischargeable electrode portion.

9. A method for exciting a gas, comprising passing a gas to be treated through a housing having an inlet opening for a gas to be treated, an outlet opening for a gas which has been treated, and at least a pair of electrodes connecting to an alternating current, and applying an alternating-current potential between
the pair of electrodes, wherein
one electrode of the pair of the electrodes is a suspended electrode arranged by placing it under a tension at a predetermined position in the housing,
the other electrode of the pair of the electrodes is a buried electrode arranged at a predetermined position by being buried in the holding wall of the housing at one end thereof,
an electrode portion of the buried electrode contains a linear or planar discharging portion as a whole, and
the electrode portion of the suspended electrode, opposed to the electrode portion of the buried electrode, has discharging portions where a distance from the electrode portion of the buried electrode becomes cyclically short.
